(19) United States
(12) Patent Application Publication
(10) Pub. No.: US 2020/0310298 A1
(43) Pub. Date: Oct. 1, 2020

(54) CARTRIDGE AND IMAGE FORMING APPARATUS

(71) Applicant: CANON KABUSHIKI KAISHA, Tokyo (JP)

(72) Inventors: Kentaro Kawata, Suntou-gun (JP); Yasushi Katsuta, Tokyo (JP); Kohei Matsuda, Fujisawa-shi (JP); Shun Sato, Minamiashigara-shi (JP); Hiraku Sasaki, Susono-shi (JP); Hiroki Ogino, Mishima-shi (JP)

(21) Appl. No.: 16/832,068

(22) Filed: Mar. 27, 2020

(30) Foreign Application Priority Data
Mar. 29, 2019 (JP) 2019-068039

(51) Int. Cl. G03G 15/08; G03G 21/00

(52) U.S. Cl. CPC G03G 15/0891; G03G 21/0011; G03G 15/0812; G03G 15/0865; G03G 15/0896

(57) ABSTRACT

A cartridge includes a housing that has an opening and a conveyance member disposed near a bottom surface of the housing. The conveyance member is configured to convey developer along a first direction from a deep side to an opening side of the housing, or a second direction from the opening side to the deep side. The cartridge also includes a driving member connected to one end of the conveyance member, with the driving member being configured to reciprocate the conveyance member along a surface direction of the conveyance member in a manner such that a maximum acceleration of the conveyance member in the first direction and a maximum acceleration in the second direction are different from each other. The housing includes a regulation member that regulates movement of the conveyance member in a direction in which the conveyance member moves away from the bottom surface of the housing.

### BACKGROUND OF THE INVENTION

### Field of the Invention

The present invention relates to a cartridge and an image forming apparatus. In particular, the present invention relates to an electrophotographic image forming apparatus and a cartridge to be used for electrophotographic image forming.

### Description of the Related Art

Conventionally, a configuration is known in which a plate-shaped conveyance member is disposed along a bottom surface (a surface direction) of a developer container, and the plate-shape conveyance member is reciprocated based on an acceleration difference, so that developer accumulated on a top surface of the conveyance member is conveyed in a predetermined direction. See Japanese Patent Application Laid-Open No. 2015-92223.

Specifically, in Japanese Patent Application Laid-Open No. 2015-92223, in reciprocating directions of the plate-shaped conveyance member, one end of the plate-shaped conveyance member is connected to a drive mechanism, and the other end is a free end. The one end of the conveyance member is driven by the drive mechanism so that the conveyance member reciprocates. As a result, the developer on the top surface is conveyed in the predetermined direction based on the acceleration difference.

In the configuration discussed in Japanese Patent Application Laid-Open No. 2015-92223, the position of the one end (a fixed end) connected to the drive mechanism is determined relative to the bottom surface of the container, but the other end (the free end) is not regulated when the plate-shaped conveyance member reciprocates. Thus, there is a case where the free end of the conveyance member easily deviates from the original position when the developer enters (flows into) a portion between the conveyance member and the bottom surface of the container. In this case, the developer cannot be stably conveyed in the predetermined direction due to a change in posture of the conveyance member.

### SUMMARY OF THE INVENTION

The present invention is related to a cartridge and an image forming apparatus that are capable of inhibiting a change in posture of a conveyance member in conveyance operation.

According to an aspect of the present invention, a cartridge includes a housing that stores developer and has an opening side and a deep side that is opposite to the opening side, with an opening formed in the housing at the opening side, a conveyance member disposed near a bottom surface of the housing, and configured to convey the developer in the housing, while bearing the developer on a top surface thereof, along a first direction from the deep side to the opening side or a second direction from the opening side to the deep side, a driving member connected to one end of the conveyance member, and configured to reciprocate the conveyance member along a surface direction of the conveyance member in such a manner that a maximum acceleration of the conveyance member in the first direction and a maximum acceleration of the conveyance member in the second direction are different from each other, and a regulation member provided with the housing, that regulates movement of the conveyance member in a direction in which the conveyance member moves away from the bottom surface of the housing.

Further features of the present invention will become apparent from the following description of exemplary embodiments with reference to the attached drawings.

### BRIEF DESCRIPTION OF THE DRAWINGS

FIG. 1A is a cross-sectional conceptual diagram of a toner storage portion of a development unit in an image forming apparatus according to a first exemplary embodiment of the present invention, and FIG. 1B is a perspective conceptual diagram of the toner storage portion of the first exemplary embodiment.

FIG. 2 is a cross-sectional conceptual diagram of the image forming apparatus according to the first exemplary embodiment of the present invention.

FIG. 3 is a cross-sectional conceptual diagram of a process cartridge of the image forming apparatus according to the first exemplary embodiment of the present invention.

FIG. 4A is a cross-sectional conceptual diagram of a toner storage portion of a development unit in an image forming apparatus according to a second exemplary embodiment of the present invention, and FIG. 4B is a perspective conceptual diagram of the toner storage portion of the second exemplary embodiment.

FIG. 5A is a cross-sectional conceptual diagram of a toner storage portion of a development unit in an image forming apparatus according to a third exemplary embodiment of the present invention, and FIG. 5B is a perspective conceptual diagram of the toner storage portion of the third exemplary embodiment.

FIG. 6A is a cross-sectional conceptual diagram of a toner storage portion of a development unit in an image forming apparatus according to a fourth exemplary embodiment of the present invention, FIG. 6B is a perspective conceptual diagram of the toner storage portion of the fourth exemplary embodiment, and FIG. 6C is an enlarged conceptual diagram of a main part of the toner storage portion of the fourth exemplary embodiment.

FIG. 7 is a cross-sectional conceptual diagram of a process cartridge of an image forming apparatus according to a fifth exemplary embodiment of the present invention.

FIG. 8A is a cross-sectional conceptual diagram of a removed toner storage portion of a cleaning unit in the image forming apparatus according to the fifth exemplary embodiment of the present invention, and FIG. 8B is a perspective conceptual diagram of the removed toner storage portion of the fifth exemplary embodiment.

### DESCRIPTION OF THE EMBODIMENTS

The present invention can be implemented as an embodiment of an image forming apparatus, and also as an embodiment of a cartridge that forms a part of the image forming apparatus.

An electrophotographic image forming apparatus according to an embodiment of the present invention will be described below with reference to the drawings. Each of exemplary embodiments to be described below is intended to exemplify the present invention, and the dimensions, materials, shapes, and relative positional relationships of components to be described below are not intended to limit the scope of the present invention thereto, unless otherwise specified.

Herein, the electrophotographic image forming apparatus forms an image on a recording medium using an electrophotographic image forming system. Examples of the electrophotographic image forming apparatus include an electrophotographic copying machine, an electrophotographic printer (e.g., a laser beam printer and a light emitting diode (LED) printer), a facsimile apparatus, and a word processor.

Further, any one of a toner cartridge, a development cartridge (a photosensitive member), a drum cartridge, and a process cartridge can be included as the “cartridge” that forms a part of the image forming apparatus. Any of these cartridges is attachable to and detachable from a main body of the electrophotographic image forming apparatus.

The toner cartridge has at least a conveyance member that conveys toner (a developer). The development cartridge has at least a development unit. The drum cartridge has at least an image bearing member (a photosensitive drum). Meanwhile, the process cartridge is a cartridge in which at least one process unit such as a charging unit, a development unit, or a cleaning unit is integral with a photosensitive drum. For example, the development unit and the photosensitive drum may be integrated into the process cartridge.

In the following description, a longitudinal direction of the cartridge is an axial direction of the image bearing member.

### (1) Image Forming Apparatus

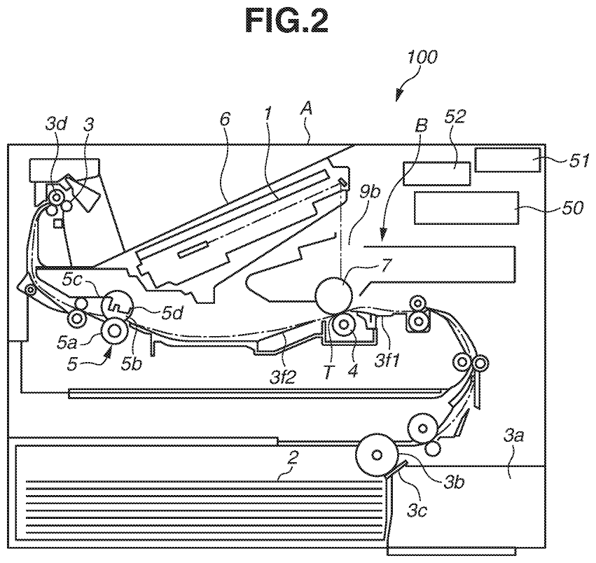

First, the entire configuration of the electrophotographic image forming apparatus will be described with reference to FIG. 2.

FIG. 2 is a cross-sectional conceptual diagram of an image forming apparatus according to a first exemplary embodiment of the present invention. Specifically, FIG. 2 schematically illustrates an image forming apparatus 100 to which a process cartridge (hereinafter referred to as “cartridge B”) is attached. To be more specific, FIG. 2 is a schematic cross-sectional conceptual diagram of a laser beam printer serving as an example of the image forming apparatus 100.

The image forming apparatus 100 includes an apparatus main body A, and the cartridge B detachably attached to the apparatus main body A. A photosensitive drum 7 serving as an image bearing member is positioned inside the apparatus main body A.

The photosensitive drum 7 is irradiated with light from a laser scanner 1 serving as an optical unit (an optical device), so that an electrostatic latent image is formed on the photosensitive drum 7.

The electrostatic latent image formed on the photosensitive drum 7 is developed by developer (hereinafter referred to as “toner”), so that a toner image is formed. In synchronization with this formation of the toner image, recording media (e.g., recording sheets, overhead projector (OHP) sheets, and pieces of cloth) 2 are separated and fed from a cassette 3a, one by one, by a pickup roller 3b and a pressure contact member 3c in pressure contact with the pickup roller 3b.

The recording medium 2 is conveyed along a conveyance guide 3f1 to a transfer portion T where the photosensitive drum 7 of the cartridge B and a transfer roller 4 serving as a transfer unit face each other. The transfer roller 4 to which a voltage is applied transfers the toner image formed on the photosensitive drum 7 to the recording medium 2 conveyed to the transfer portion T, and then the recording medium 2 is conveyed to a fixing device 5 along a conveyance guide 3f2.

The fixing device 5 includes a driving roller 5a and a fixing rotation member 5d. The fixing rotation member 5d includes a heater 5b built therein and is configured of a cylindrical sheet rotatably supported by a support member 5c. The fixing device 5 fixes the transferred toner image by applying heat and pressure to the passing recording medium 2.

A discharge roller 3d is configured to convey the recording medium 2 to which the toner image is fixed, and then discharge the recording medium 2 to a discharge portion 6 through a reversal conveying path. In the present exemplary embodiment, components such as the pickup roller 3b, the pressure contact member 3c, and the discharge roller 3d are included in a conveyance device 3.

An interface portion 51 is an interface between an external apparatus such as a personal computer (PC) and the image forming apparatus 100, and is connected to a central processing unit (CPU) 52. The CPU 52 controls various operations of the image forming apparatus 100 and processes data. For example, the CPU 52 controls the driving of each component and voltage application via a controller 50.

### (2) Process Cartridge (Cartridge)

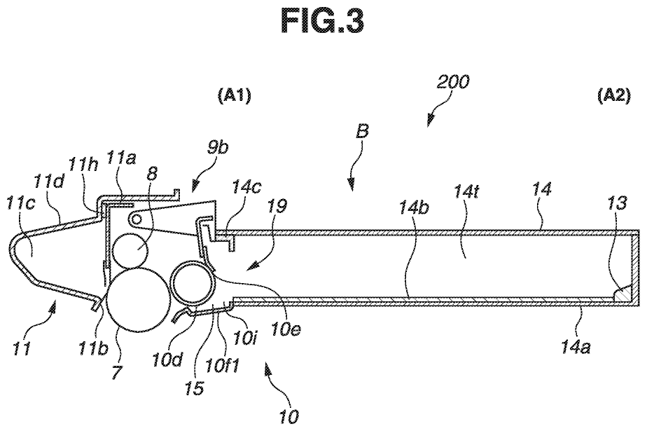

Next, a configuration of the cartridge B will be described with reference to FIG. 3.

FIG. 3 is a cross-sectional conceptual diagram of the process cartridge of the image forming apparatus according to the first exemplary embodiment of the present invention. As illustrated in FIG. 3, the cartridge B (the process cartridge) includes the photosensitive drum 7 serving as the “image bearing member” that bears a developed image, and at least one process unit. Here, examples of the process unit include a charging unit that charges the photosensitive drum 7, a development unit that develops an electrostatic latent image formed on the photosensitive drum 7, and a cleaning unit for cleaning the toner remaining on the photosensitive drum 7 after a toner image has been transferred from the photosensitive drum 7 to a recording medium.

The cartridge B rotates the photosensitive drum 7 having a photosensitive layer, and uniformly charges the surface of the photosensitive drum 7 by applying a voltage to a charging roller 8 serving as the charging unit. The surface of the charged photosensitive drum 7 is exposed to light (a light image) through an exposure opening 9b based on image information from the laser scanner 1. An electrostatic latent image is thereby formed on the surface of the photosensitive drum 7. The electrostatic latent image formed on the surface of the photosensitive drum 7 is developed by a development device 10 (the development unit). The development unit may be configured as a cartridge to be detachably attached to the apparatus main body or a configuration such as the drum cartridge.

A storage container 14 serving as a “conveyance mechanism container” is formed of a housing 14a, a developer conveyance board 14b, and an opening member 14c. The storage container 14 stores the toner in a toner storage portion 14t of the storage container 14.

The storage container 14 is connected to the development device 10 by the opening member 14c of the storage container 14. A development chamber 10i of the development device 10 and the toner storage portion 14t of the storage container 14 are in fluid communication with each other via an opening portion 19 (an opening) of the opening member 14c.

The developer conveyance board (hereinafter referred to as “conveyance board”) 14b serving as the “conveyance member” sends the toner in the toner storage portion 14t to the development chamber 10i through the opening portion 19 of the opening member 14c.

Subsequently, the development device 10 rotates a development roller 10d that bears the developer. With this rotation, a toner layer to which triboelectric charges are applied by a development blade 10e is formed on the surface of the development roller 10d, and the toner is transferred to the photosensitive drum 7 based on the electrostatic latent image, so that the toner image is formed as a visual image.

Further, the toner image is transferred to the recording medium 2 by application to the transfer roller 4 of a voltage having the polarity opposite to that of the toner image. Subsequently, a cleaning blade 11a fixed to a drum housing 11d by a fixing portion 11h scrapes off the toner remaining on the photosensitive drum 7. A scooping sheet 11b scoops the scraped toner such that the scooped toner is collected in a removed toner storage portion 11c that stores the removed toner. The toner remaining on the photosensitive drum 7 after a toner image has been transferred from the photosensitive drum 7 to a recording medium is thus removed by these cleaning members.

### (3) Toner Conveyance Configuration

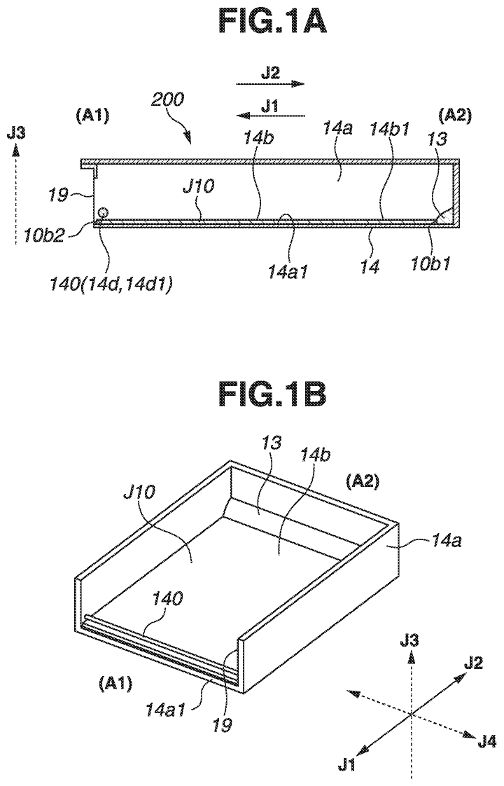

Next, an example of a toner conveyance configuration of a developer storage unit will be described with reference to FIGS. 1A and 1B. FIG. 1A is a cross-sectional conceptual diagram of the toner storage portion of the development unit in the image forming apparatus according to the first exemplary embodiment of the present invention. FIG. 1B is a perspective conceptual diagram of the toner storage portion of the first exemplary embodiment.

In the present exemplary embodiment, the developer storage unit has the storage container 14, the conveyance board 14b, and an oscillating body 13 (a driving member) serving as an “oscillation source”, as illustrated in FIGS. 1A and 1B. A polyethylene terephthalate (PET) sheet having a thickness of 100 μm is used as the conveyance board 14b, and a piezo actuator having variable oscillation conditions (such as a frequency, acceleration, and amplitude) is used as the oscillating body 13.

The conveyance board 14b is disposed under the toner, and the oscillating body 13 is attached to a side 10b1 (one end) at a position farthest from the opening portion 19. A side 10b2 at a position closest to the opening portion 19, i.e., a side opposite the side where the oscillating body 13 is attached, is a free end.

Reciprocating oscillation in a toner conveyance direction J1 (a first direction) and a direction J2 (a second direction) opposite thereto is applied from the oscillating body 13 to the conveyance board 14b such that the toner is conveyed in the conveyance direction J1. Here, a conveyance speed for the toner can be adjusted by the oscillation conditions for the surface of the conveyance board 14b. For example, the adjustment can be made by using various oscillation parameters, such as frequency, acceleration difference between forward movement and backward movement, and amplitude. In the present exemplary embodiment, the acceleration of the forward movement (the first direction J1) of the reciprocation of the conveyance board 14b is 10 m/s², the acceleration of the backward movement (the second direction J2) is 15 m/s² (therefore, the acceleration difference of the reciprocation is 5 m/s²), the amplitude is 0.5 mm, and the frequency is 10 Hz, based on the reciprocating oscillation of the oscillating body 13.

In the present exemplary embodiment, the first direction J1 is a direction from a deep side (A2) to an opening side (A1), and the second direction J2 is a direction from the opening side to the deep side, as illustrated in FIGS. 1A and 1B. Further, a surface direction J10 of the conveyance board 14b is a direction substantially parallel to a bottom surface 14a1 of the housing 14a. A direction intersecting (orthogonal to) the surface direction J10 is a first intersecting direction J3. A direction intersecting (orthogonal to) the first direction J1 and the second direction J2 is a second intersecting direction J4. In the present exemplary embodiment, the first intersecting direction J3 can be the upward direction relative to the gravitational direction. The first intersecting direction J3 is also a direction in which a top surface 14b1 of the conveyance board 14b moves away from the bottom surface 14a1 of the housing 14a, as will be described below.

The oscillating body 13 is controlled by the CPU 52 via the controller 50, and the above-described various oscillation parameters can be freely controlled at desired timing.

### (4) Free End Position Regulation Member (Regulation Member)

A wire 14d made of stainless steel and having a diameter of 1 mm is disposed above the free end of the conveyance board 14b and held to extend from end to end in the longitudinal direction of the cartridge B. The wire 14d serves as a “free end position regulation member 140 (the regulation member)”. The free end position regulation member 140 regulates the movement range of the free end of the conveyance board 14b in the directions J3 and J4, but not the directions J1 and J2 that are the original oscillation directions such that the free end of the conveyance board 14b constantly falls within a predetermined range. Thus, even if, for example, the posture of the apparatus main body A or the cartridge B is vertically reversed (upside down), curling up of the free end does not occur and toner conveyance performance is therefore not reduced. The wire 14d is disposed so as not to be in constant contact with the conveyance board 14b to thereby prevent obstruction of the oscillation of the conveyance board 14b.

Note, the position of the free end position regulation member 140, as well as the material to be used, size, and shape of the free end position regulation member 140 may only have to be set as within a range in which the free end can be prevented from deviating from the normal position and the toner conveyance is not obstructed. The configuration of the free end position regulation member 140 is not limited to the configuration of the present exemplary embodiment.

A second exemplary embodiment is basically similar to the first exemplary embodiment in terms of configuration. The second exemplary embodiment is different from the first exemplary embodiment with respect to a free end position regulation member of a conveyance board 14b. In the second exemplary embodiment, the other portions of the configuration are basically similar to those of the first exemplary embodiment, and a similar effect can be obtained.

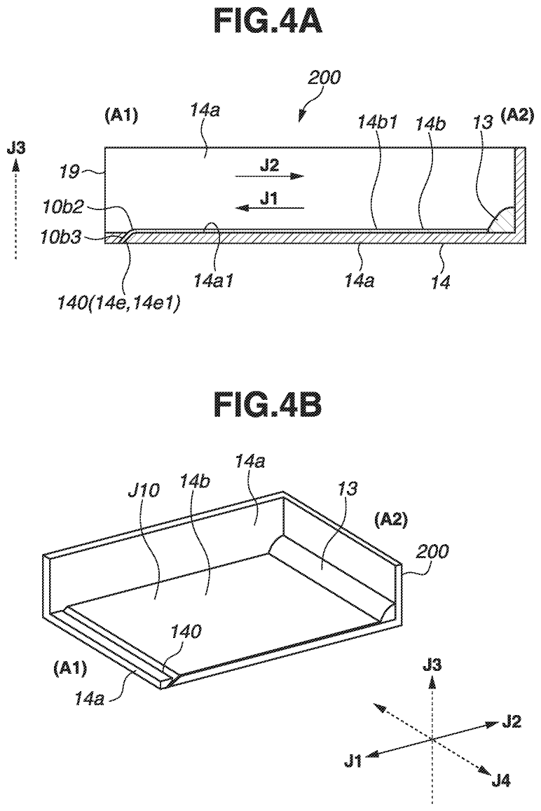

Details of the configuration of the regulation member of the second exemplary embodiment will be described below with reference to FIGS. 4A and 4B.

FIG. 4A is a cross-sectional conceptual diagram of a toner storage portion of a development unit in an image forming apparatus according to the second exemplary embodiment of the present invention. FIG. 4B is a perspective conceptual diagram of the toner storage portion of the second exemplary embodiment. In FIG. 4B, a wall on the near side of a housing of a storage container is omitted.

As illustrated in FIGS. 4A and 4B, a groove 14e acts as a “free end position regulation member 140 (the regulation member).” The groove 14e is provided in a bottom surface 14a1 of a housing 14a of a storage container 14, at a position facing the back of a toner conveyance surface (a top surface) of the conveyance board 14b. The groove 14e runs from end to end in the longitudinal direction of the cartridge B and can hold the free end of the conveyance board 14b. A width of the groove 14e in a toner conveyance direction is 0.5 mm, and a depth of the groove 14e is 1 mm, which is deep enough to prevent the free end of the conveyance board 14b from disengaging from the groove 14e even if the conveyance board 14b reciprocates. Because the groove 14e holds the free end of the conveyance board 14b, the effect of regulating a movement range in directions other than the original oscillation directions of the free end can be obtained, as in the configuration described in the first exemplary embodiment.

A third exemplary embodiment is basically similar to the first exemplary embodiment in terms of configuration. The third exemplary embodiment is different from the first exemplary embodiment with respect to a free end position regulation member of a conveyance board 14b. In the third exemplary embodiment, the other portions of the configuration are basically similar to those of the first exemplary embodiment, and a similar effect can be obtained.

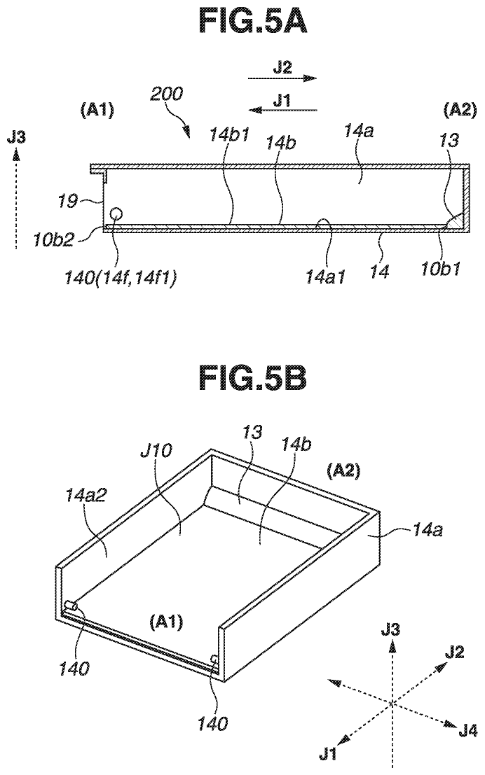

Details of the configuration of the regulation member of the third exemplary embodiment will be described below with reference to FIGS. 5A and 5B.

FIG. 5A is a cross-sectional conceptual diagram of a toner storage portion of a development unit in an image forming apparatus according to the third exemplary embodiment of the present invention. FIG. 5B is a perspective conceptual diagram of the toner storage portion of the third exemplary embodiment.

As illustrated in FIGS. 5A and 5B, a protrusion 14f shaped like a column is disposed on an inner wall on each of both side surfaces of a housing of a storage container 14, with the protrusion 14f acting as a “free end position regulation member 140 (the regulation member)”. The protrusion 14f is disposed not in constant contact with the conveyance board 14b, and therefore does not obstruct the oscillation of the conveyance board 14b. The protrusion 14f makes it possible to obtain the effect of regulating movement ranges in directions other than the original oscillation directions of the free end, as in the configuration described in the first exemplary embodiment. The size, shape, and position of the protrusion 14f can be set as appropriate.

A fourth exemplary embodiment is basically similar to the first exemplary embodiment in terms of configuration. The fourth exemplary embodiment is different from the first exemplary embodiment with respect to a free end position regulation member of a conveyance board 14b. In the fourth exemplary embodiment, the other portions of the configuration are basically similar to those of the first exemplary embodiment, and a similar effect can be obtained.

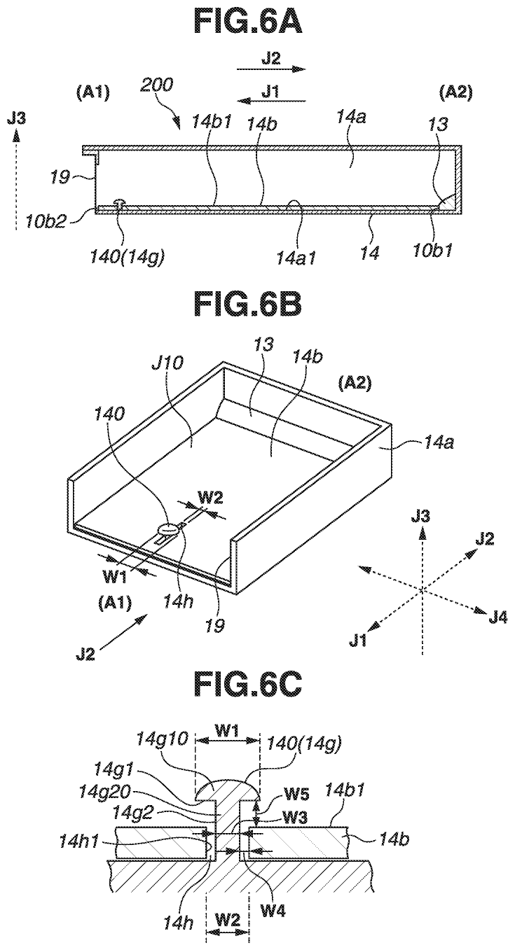

Details of the configuration of the regulation member of the fourth exemplary embodiment will be described below with reference to FIGS. 6A, 6B, and 6C.

FIG. 6A is a cross-sectional conceptual diagram of a toner storage portion of a development unit in an image forming apparatus according to the fourth exemplary embodiment of the present invention. FIG. 6B is a perspective conceptual diagram of the toner storage portion of the fourth exemplary embodiment. FIG. 6C is an enlarged conceptual diagram of a main part of the toner storage portion of the fourth exemplary embodiment.

As illustrated in FIGS. 6A to 6C, a protrusion 14g (a protruding portion) with a step is disposed on an inner wall of a bottom surface of a housing of a storage container 14, with the protrusion 14g acting as a “free end position regulation member 140 (the regulation member)”. The protrusion 14g passes through an ellipse-shaped hole (a slot) 14h provided in the conveyance board 14b. The protrusion 14g includes a large diameter portion 14g10 and a small diameter portion 14g20. The large diameter portion 14g10 includes a first regulation portion 14g1, and the small diameter portion 14g20 includes a second regulation portion 14g2.

A diameter (width) w1 of the large diameter portion 14g10 of the protrusion 14g is longer than a short-side length (width) w2 of the hole 14h (a through-hole), so that curling up of the conveyance board 14b can be prevented. In other words, the first regulation portion 14g1 can prevent a free end side 10b2 of the conveyance board 14b from rising (moving away from the bottom surface of the housing in a direction J3).

In the present exemplary embodiment, a diameter (width) W3 of the small diameter portion is smaller than the short-side length W2 of the hole 14h, and a predetermined clearance (width) W4 is formed between the small diameter portion and a sidewall 14h1 of the hole. Further, a predetermined interval distance (width) W5 is formed between the large diameter portion and a top surface 14b1 of the conveyance board 14b.

In the present exemplary embodiment, the large diameter portion is configured to extend in a direction orthogonal to the directions J1 and J2 to be engageable in the hole 14h. However, the large diameter portion may be configured to extend in the directions J1 and J2 to be engageable in the hole 14h.

The protrusion 14g is disposed not to be in constant contact with the conveyance board 14b, and therefore does not obstruct the oscillation of the conveyance board 14b. This configuration makes it possible to obtain the effect of regulating a movement range in directions other than the original oscillation directions of the free end, as in the configuration described in the first exemplary embodiment.

In the above-described first to fourth exemplary embodiments, the configuration of the present invention has been described in configurations where the developer conveyance mechanism 200 is used inside the storage container 14 (see, for example, FIG. 1A).

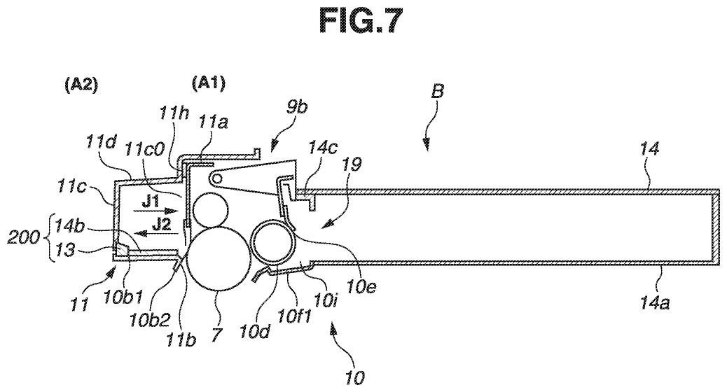

In a fifth exemplary embodiment, another configuration will be described with reference to FIG. 7. In this configuration, a developer conveyance mechanism 200 is positioned inside of a removed toner storage portion 11c, which acts as a “conveyance mechanism container” that stores toner removed from a surface of a photosensitive drum 7 by a cleaning blade 11a acting as a “cleaning member”. FIG. 7 is a cross-sectional conceptual diagram of a process cartridge in an image forming apparatus according to the fifth exemplary embodiment of the present invention.

In the present exemplary embodiment, waste toner and foreign substance(s) removed from the surface of the photosensitive drum 7 by the cleaning blade 11a are stored in the removed toner storage portion 11c, and the removed storage portion 11c is sealed by a scooping sheet 11b serving as a “leakage prevention member”.

### (1) Process Cartridge (Cartridge)

Next, a configuration of a cartridge B of the present exemplary embodiment will be described with reference to FIG. 7.

In the first exemplary embodiment, the developer conveyance mechanism 200 is provided inside a toner storage portion 14t. However, in the present exemplary embodiment, the developer conveyance mechanism 200 is provided inside the removed toner storage portion 11c. In other words, the example in which the present invention is applied to the development unit has been described in the first exemplary embodiment, whereas a configuration in which the present invention is applied to a removed toner storage unit is described in the fifth exemplary embodiment.

In the present exemplary embodiment, the removed toner storage unit includes the removed toner storage portion 11c, a conveyance board 14b, and an oscillating body 13 acting as an “oscillation condition adjustment member”. A PET sheet having a thickness of 100 μm is used as the conveyance board 14b, and a piezo actuator having variable oscillation conditions (such as a frequency, an acceleration, and an amplitude) is used as the oscillating body 13. The oscillation conditions are similar to those described in the first to fourth exemplary embodiments.

The conveyance board 14b is disposed on a housing bottom surface of the removed toner storage portion 11c, and the oscillating body 13 is attached to a side 10b1 at a position farthest from the cleaning blade 11a. A side 10b2 at a position closest to the cleaning blade 11a (i.e., a side opposite the side to which the oscillating body 13 is attached) is a free end. The toner removed from the surface of the photosensitive drum 7 by the cleaning blade 11a falls in the gravitational direction and is then conveyed by the conveyance board 14b in a second direction J2. This reduces build-up of the removed toner near the cleaning blade 11a and prevents toner from leaking near the scooping sheet 11b resulting from a reduction in cleaning performance or an increase in particle pressure.

### (2) Free End Position Regulation Member (Regulation Member)

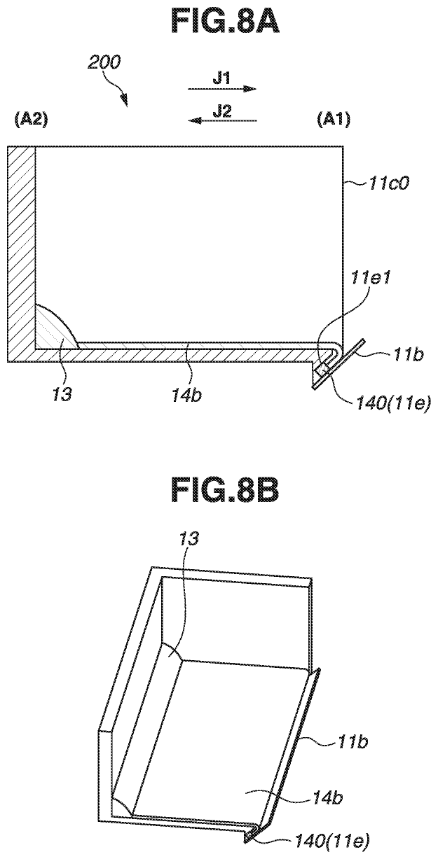

Next, a configuration of a free end position regulation member of the present exemplary embodiment will be described with reference to FIGS. 8A and 8B.

FIG. 8A is a cross-sectional conceptual diagram of the removed toner storage portion of the cleaning unit in the image forming apparatus according to the fifth exemplary embodiment of the present invention. FIG. 8B is a perspective conceptual diagram of the removed toner storage portion of the fifth exemplary embodiment.

As illustrated in FIGS. 8A and 8B, a groove 11e (a clearance portion) acting as a “free end position regulation member 140” is provided between the housing (container) bottom surface of the removed toner storage portion 11c and an affixing bearing surface 11c1 of the scooping sheet 11b. Further, the conveyance board 14b is configured to be folded near the free end so that the free end is held in the groove 11e. The effect of regulating a movement range in directions other than the original oscillation directions of the free end can be thereby obtained, as in the configuration described in the first exemplary embodiment.

As described in the first to fifth exemplary embodiments, the free end of the conveyance member can be prevented from deviating from the normal position such that favorable powder conveyance performance can be maintained in the image forming apparatus having a powder conveyance mechanism for conveying powder by oscillating the conveyance member shaped like a plate.

In the first to fourth exemplary embodiments, the developer conveyance mechanism 200 (including the regulation member) is disposed inside the storage container 14 for storing the developer. As shown in the fifth exemplary embodiment, the present invention is also applicable to the case where the developer conveyance mechanism 200 is disposed in the removed toner storage portion 11c (housing) that stores the removed toner.

A configuration of the present invention can be summarized as follows.

A cartridge B according to an exemplary embodiment of the present invention includes a housing 14a that has an opening 19 and stores developer, a conveyance member 14b that conveys the developer in the housing 14a while bearing the developer on its top surface 14b1, and a driving member 13 that reciprocates the conveyance member 14b. The conveyance member 14b is disposed near a bottom surface 14a1 of the housing 14a. Further, the conveyance member 14b conveys the developer in the housing 14a along a first direction J1 from a deep side (A2) to the opening side (A1) or a second direction J2 from the opening side to the deep side. The deep side (A2) is opposite to the opening side (A1) in the housing. The driving member 13 is connected to one end 10b1 of the conveyance member, and reciprocates the conveyance member 14b along a surface direction J10 of the conveyance member 14b in such a manner that a maximum acceleration of the conveyance member 14b in the first direction and a maximum acceleration of the conveyance member 14b in the second direction are different from each other. The housing 14a includes a regulation member 140 (14d, 14e, 14f, 14g, or 11e) that regulates movement of the conveyance member in a direction J3 in which the conveyance member 14b moves away from the bottom surface 14a1 of the housing 14a. Furthermore, in the cartridge according to the exemplary embodiment of the present invention, the driving member 13 is connected to the one end 10b1, located on the deep side, of the conveyance member 14b, and the regulation member 140 can regulate movement of the other end 10b2, located on the opening side, of the conveyance member 14b.

In the cartridge according to an exemplary embodiment of the present invention, the regulation member 140 can include a first regulation portion (14d1, 14e1, 14f1, 14g1, or 11e1) that regulates movement of the conveyance member 14b in the first intersecting direction J3 that intersects the surface direction J10 of the top surface 14b1 of the conveyance member 14b. Still further, the first regulation portion may be configured to permit the movement of the conveyance member in a case where a moving amount of the conveyance member 14b with respect to the housing 14a in the first intersecting direction J3 is less than or equal to a first predetermined value, and to regulate the movement of the conveyance member so that the moving amount does not exceed the first predetermined value. In other words, movement in a vertical direction (a gravitational direction) at a free end of the conveyance member 14b can be regulated. Moreover, the regulation member 140 and the conveyance member 14b may be disposed not to be in contact with each other, and the conveyance member 14b may be brought into contact with the regulation member 140 for the first time (may be regulated by the regulation member 140) when the conveyance member 14b moves in a direction (e.g., the direction J3) other than reciprocating directions for a predetermined amount or more.

In the cartridge according to an exemplary embodiment of the present invention, the regulation member 140 is disposed on a side surface (14a2) of the housing 14a in a posture during use so that the movement of the conveyance member 14b in the first intersecting direction (gravitational direction) J3 can be regulated by the regulation member 140 and the bottom surface 14a1.

In the cartridge according to an exemplary embodiment of the present invention, the regulation member 140 can be configured as a member 14d having a wire shape. Furthermore, the regulation member 140 can be configured as a protruding portion 14f that protrudes from the side surface 14a2 toward the inside of the housing 14a.

In the cartridge according to an exemplary embodiment of the present invention, the regulation member 140 has a groove portion 14e provided in the bottom surface 14a1 of the housing 14a, and at least a part 10b3 of the end portion 10b2 of the conveyance member 14b can enter the groove portion 14e.

In the cartridge according to an exemplary embodiment of the present invention, the regulation member 140 can include a second regulation portion 14g2 that regulates movement of the conveyance member 14b in a second intersecting direction J4 that intersects the first direction J1 and the second direction J2, of the surface direction J10 of the top surface 14b1 of the conveyance member 14b. Furthermore, the second regulation portion 14g2 may be configured to permit the movement of the conveyance member 14b in a case where a moving amount of the conveyance member 14b with respect to the housing 14a in the second intersecting direction J4 is less than or equal to a second predetermined value, and to regulate the movement of the conveyance member so that the moving amount does not exceed the second predetermined value. In other words, movement in a direction that intersects (e.g., is orthogonal to) the reciprocating directions at the free end of the conveyance member 14b of the surface direction can be regulated. Moreover, the regulation member 140 and the conveyance member 14b may be disposed not to be in contact with each other, and the conveyance member 14b may be brought into contact with the regulation member 140 for the first time (may be regulated by the regulation member 140) when the conveyance member 14b moves in a direction (e.g., the direction J4) other than the reciprocating directions by a predetermined amount or more.

In a cartridge according to an exemplary embodiment of the present invention, the regulation member 140 can have the protruding portion 14g that protrudes from the bottom surface 14a1 of the housing 14a toward the conveyance member 14b, and the conveyance member 14b can have a through-hole 14h passing therethrough in a thickness direction. Furthermore, the protruding portion 14g can have a large diameter portion 14g10 located on the tip side and a small diameter portion 14g20 connecting the large diameter portion 14g10 and the bottom surface 14a1, and the small diameter portion 14g20 may be configured to pass through the through-hole 14h.

In a cartridge according to an exemplary embodiment of the present invention, the conveyance member 14b may include a flexible sheet-shaped member.

In a cartridge according to an exemplary embodiment of the present invention, the conveyance member 14b may be disposed to extend along the bottom surface 14a1 of the housing 14a in a posture during use.

A cartridge according to an exemplary embodiment of the present invention can further include a developer bearing member 10d disposed at the housing (near the opening 19) and configured to bear the developer. The conveyance member 14b can be driven by the driving member 13 in such a manner that a maximum acceleration of the conveyance member 14b in the second direction J2 is greater than a maximum acceleration of the conveyance member 14b in the first direction J1, and the conveyance member 14b can convey the developer from the deep side to the opening side of the housing 14a. In other words, a cartridge according to an exemplary embodiment of the present invention can be configured as any one of a developer container 14 (a developer cartridge), a development cartridge, and a process cartridge, in which the conveyance member 14b is housed in the housing 14a.

A cartridge according to an exemplary embodiment of the present invention can further include an image bearing member 7 disposed at an opening 11C0 of a housing 11c and configured to bear a developed image. The conveyance member 14b can be driven by the driving member 13 in such a manner that a maximum acceleration of the conveyance member 14b in the second direction J2 is lower than a maximum acceleration of the conveyance member 14b in the first direction J1, and the conveyance member 14b can convey the developer from the opening side A1 to the deep side A2 of the housing 11c. In other words, a cartridge according to an exemplary embodiment of the present invention can be configured as any one of a drum cartridge, a cleaning cartridge, and a process cartridge, in which the conveyance member 14b is housed in the housing 11c.

A cartridge according to an exemplary embodiment of the present invention can include a blade member 11a disposed in the housing 11c near the opening 11c0, with the blade member 11a being configured to clean a surface of the image bearing member 7, and a sheet member 11b disposed at the housing 11c near the opening 11c0 to abut the surface of the image bearing member (photosensitive drum) 7. An end portion 10b2 on the opening side of the regulation member 140 can enter a clearance portion 11e between the sheet member 11b and a mount portion (11c1) for mounting the sheet member 11b in the housing 11c.

It is desirable that a cartridge according to an exemplary embodiment of the present invention be attachable to and detachable from an apparatus main body A of an image forming apparatus.

An image forming apparatus according to an exemplary embodiment of the present invention includes a transfer member 4 and the above-described cartridge B.

According to a cartridge or an image forming apparatus of the exemplary embodiment of the present invention, a change in posture of the conveyance member 14b can be inhibited in conveyance operation.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2019-068039, filed Mar. 29, 2019, which is hereby incorporated by reference herein in its entirety.

What is claimed is:

1. A cartridge comprising:
a housing that stores developer, the housing having an opening side and a deep side that is opposite to the opening side, with an opening formed in the housing at the opening side;
a conveyance member disposed near a bottom surface of the housing, the conveyance member being configured to convey the developer in the housing, while bearing the developer on a top surface thereof, along a first direction from the deep side to the opening side or a second direction from the opening side to the deep side;
a driving member connected to one end of the conveyance member, the driving member being configured to reciprocate the conveyance member along a surface direction of the conveyance member in such a manner that a maximum acceleration of the conveyance member in the first direction and a maximum acceleration of the conveyance member in the second direction are different from each other; and
a regulation member provided with the housing, the regulation member being configured to regulate movement of the conveyance member in a direction in which the conveyance member moves away from the bottom surface of the housing.

2. The cartridge according to claim 1,
wherein the driving member is connected to one end of the conveyance member located on the deep side, and
wherein the regulation member regulates movement of the other end of the conveyance member located on the opening side.

3. The cartridge according to claim 1,
wherein the regulation member includes a first regulation portion that regulates movement of the conveyance member in a first intersecting direction that intersects the surface direction of the top surface of the conveyance member, and
wherein the first regulation portion permits the movement of the conveyance member in a case where a moving amount of the conveyance member with respect to the housing in the first intersecting direction is less than or equal to a first predetermined value, and the first regulation portion regulates the movement of the conveyance member so that the moving amount does not exceed the first predetermined value.

4. The cartridge according to claim 3,
wherein the regulation member is provided on a side surface of the housing when the cartridge is in a posture during use, and
wherein the movement of the conveyance member in the first intersecting direction is regulated by the regulation member and the bottom surface.

5. The cartridge according to claim 4, wherein the regulation member has a wire shape.

6. The cartridge according to claim 3,
wherein the regulation member has a groove portion provided in the bottom surface of the housing, and
wherein at least a part of an end portion of the conveyance member is configured to be able to enter the groove.

7. The cartridge according to claim 3,
wherein the regulation member includes a second regulation portion that regulates movement of the conveyance member in a second intersecting direction that intersects the first direction and the second direction, and
wherein the second regulation portion permits the movement of the conveyance member in a case where a moving amount of the conveyance member with respect to the housing in the second intersecting direction is less than or equal to a second predetermined value, and the second regulation portion regulates the movement of the conveyance member so that the moving amount does not exceed the second predetermined value.

8. The cartridge according to claim 7,
wherein the regulation member has a protruding portion that protrudes from the bottom surface of the housing toward the conveyance member,
wherein the conveyance member has a through-hole passing therethrough in a thickness direction of the conveyance member, and
wherein the protruding portion has a large diameter portion located on a tip side and a small diameter portion connecting the large diameter portion and the bottom surface, and the small diameter portion passes through the through-hole of the conveyance member.

9. The cartridge according to claim 1, wherein the conveyance member includes a flexible sheet-shaped member.

10. The cartridge according to claim 1, wherein the conveyance member is disposed to extent along the bottom surface of the housing when the cartridge is in a posture during use.

11. The cartridge according to claim 1, further comprising a developer bearing member disposed at the housing and configured to bear the developer,
wherein the conveyance member is driven by the driving member in a manner such that the maximum acceleration of the conveyance member in the second direction is greater than the maximum acceleration of the conveyance member in the first direction, and
wherein the conveyance member conveys the developer from the deep side to the opening side of the housing.

12. The cartridge according to claim 1, further comprising an image bearing member disposed at the housing and configured to bear a developed image,
wherein the conveyance member is driven by the driving member in a manner such that the maximum acceleration of the conveyance member in the second direction is less than the maximum acceleration of the conveyance member in the first direction, and
wherein the conveyance member conveys the developer from the opening side to the deep side of the housing.

13. The cartridge according to claim 12, further comprising:
a blade member disposed at the housing and configured to clean a surface of the image bearing member; and
a sheet member disposed at the housing to abut the surface of the image bearing member,
wherein an end portion on the opening side of the regulation member is configured to be able to enter a clearance portion between the sheet member and a mount portion for mounting the sheet member in the housing.

14. The cartridge according to claim 1, wherein the cartridge is configured to be attachable to and detachable from a main body of an image forming apparatus.

15. An image forming apparatus comprising:
a transfer member; and
the cartridge according to claim 1.
